(19) United States
(12) Patent Application Publication
(10) Pub. No.: US 2010/0001113 A1
(43) Pub. Date: Jan. 7, 2010

(54) Fishing rod reel with angled and extended reel neck

(76) Inventors: Kenneth Grahl, Fond-Du Lac, WI (US); Nathaniel Grahl, Fond-Du Lac, WI (US)

Correspondence Address: JACOBSON HOLMAN PLLC, 400 SEVENTH STREET N.W., SUITE 600, WASHINGTON, DC, 20004, US

(21) Appl. No.: 12/216,461

(22) Filed: Jul. 3, 2008

(51) Int. Cl. A01K 89/00

(52) U.S. Cl. 242/310; 43/20

(57) ABSTRACT

A fishing reel for a fishing rod has a reel body with a line spool, a rotor that rotates a bail around the spool, a rotor handle, and a reel mounting arm. The reel mounting arm includes a mounting foot attached to the rod and a mounting neck connecting the mounting foot to the reel body. An angle between (i) a longitudinal axis of the rod and (ii) a longitudinal axis of the mounting neck that extends from the mounting foot to a rotation axis of the rotor handle is less than 90°. An angle between a longitudinal axis of the spool and the mounting neck axis is from 54° to 84°. By virtue of the angled configurations, there is reduced friction between the line and the rod line guide nearest the reel. As a result, casting distance is increased and line retrieval is smoother.

### BACKGROUND OF THE INVENTION

1. Field of the Invention

The present invention generally relates to a fishing reel for a fishing rod. More specifically, the present invention relates to a spinning reel with a configuration that provides for longer casting and smoother retrieving of fishing line when mounted on a fishing rod.

2. Description of the Prior Art

Various types of fishing rod reels typically referred to as spinning reels are known. As shown in FIG. 1, a conventional spinning reel, generally designated by reference numeral 10, has a reel body 20 with a spool 30 that holds a supply of fishing line 40, and a reel “neck” or mounting arm, generally designated by reference numeral 50, for mounting the reel 10 to a rod, generally designated by reference numeral 80, at a rod grip section 81. The mounting arm 50 includes a mounting foot 51 that is attachable to the rod 80 and a mounting neck 55 that connects the mounting foot 51 to the reel body 20. As illustrated in FIG. 1, a longitudinal axis 31 of the spool 30 is oriented parallel to a longitudinal axis 83 of the rod 80.

An operational problem associated with such prior art reels, however, is that the angle at which the line 40 leaves the reel spool 30 at a bail 60 and extends to a line guide 82 (typically known as the “stripper guide”) positioned nearest the reel 10 is relatively steep. As a result of the steep angle, the line 40 contacts and is deflected by line guide 82. The aforementioned contact between the line 40 and the line guide 82 produces friction, which reduces casting distance and decreases the ease of retrieving the line.

Another problem associated with such prior art reels is that for certain users and in certain services there is inadequate clearance between the reel's bail 60 and the user's fingers that are holding the rod. That is because a conventional reel must be mounted relatively close to the rod in order to lessen the aforementioned angle between the line 40 leaving the reel spool 30 at the bail 60 and the line guide 82. Therefore, as the bail 60 rotates, it is prone to contact the fingers of a user that are on the rod grip section 81. This problem is especially pronounced for a user with larger fingers, and for cold weather fishing when the user wishes to wear gloves or mittens. In fact, because of the limited clearance between the bail and the rod in a conventional spinning reel, the wearing of gloves or mittens can be either difficult or impossible.

### SUMMARY OF THE INVENTION

The present invention overcomes the above-described limitations of the prior art by providing a fishing rod reel that has an angled configuration between the rod and a longitudinal axis of the line spool. By virtue of the angled design, there is reduced friction between the line and the rod line guide nearest the reel. As a result, casting distance is increased and line retrieval is smoother.

According to a preferred embodiment of the present invention, the reel includes generally a reel body with a spool holding a supply of fishing line, a rotor that rotates a bail around the spool, a rotor handle rotatably disposed in the reel body, and a reel “neck” or mounting arm configured for mounting the reel to the rod. The mounting arm includes a mounting foot that is attachable to the rod and a mounting neck that connects the mounting foot to the reel body.

One feature of the present invention is the altered angle of the reel mounting arm relative to both the rod and to the line spool. The mounting arm is configured such that an angle between (i) a longitudinal axis of the rod and (ii) a longitudinal axis of the mounting neck that extends from the mounting foot to a rotation axis of the rotor handle is less than 90°.

Another feature of the present invention is the configuration of the reel body such that an angle between a longitudinal axis of the spool and the mounting neck axis is from 54° to 84°.

Still another feature of the present invention is the mounting of the reel at an increased distance away from the rod grip by virtue of the configurations of the mounting neck and of the reel body. That is, the aforementioned configurations provide an angle between the line leaving the reel spool at the bail and the first line guide that is less severe than that associated with a conventional spinning reel. As a result, the reel can be mounted at a greater distance away from the rod grip, thereby providing increased clearance between the reel's bail and the user's fingers.

An object of the present invention, therefore, is to provide a reel with a mounting arm that has an altered angle relative to both the rod and to the line spool so that friction between the line and the rod line guide nearest the reel is reduced relative to that of a conventional reel, thereby providing for increased casting distance and smoother line retrieval.

Another object of the present invention is to provide a reel with a mounting arm that is configured such that an angle between (i) a longitudinal axis of the rod and (ii) a longitudinal axis of a mounting neck that extends from a mounting foot to a rotation axis of a rotor handle is less than 90°.

Still another object of the present invention is to provide a reel with a reel body that is configured such that an angle between a longitudinal axis of a line spool and the mounting neck axis is from 54° to 84°.

Yet another object of the present invention is to provide a reel that can be mounted at an increased distance away from the rod grip, thereby providing increased clearance between the reel's bail and the user's fingers.

Still another object of this invention to be specifically enumerated herein is to provide a reel in accordance with the preceding objects that will conform to conventional forms of manufacture, be of relatively simple construction and easy to use so as to provide a device that will be economically feasible, long lasting, durable in service, relatively trouble free in operation, and a general improvement in the art.

These together with other objects and advantages which will become subsequently apparent reside in the details of construction and operation as more fully hereinafter described and claimed, reference being had to the accompanying drawings forming a part hereof, wherein like reference numbers refer to like parts throughout. The accompanying drawings are intended to illustrate the invention, but are not necessarily to scale.

### BRIEF DESCRIPTION OF THE DRAWINGS

FIG. 1 is a side view of a conventional (prior art) fishing rod and reel.

FIG. 2 is a side view of one embodiment of a fishing rod and reel in accordance with the present invention.

FIG. 3 is an enlarged schematic side view of the reel shown in FIG. 2.

### DETAILED DESCRIPTION OF THE PREFERRED EMBODIMENTS

Although preferred embodiments of the invention are explained in detail, it is to be understood that other embodiments are possible. Accordingly, it is not intended that the invention is to be limited in its scope to the details of constructions, and arrangement of components set forth in the following description or illustrated in the drawings. The invention is capable of other embodiments and of being practiced or carried out in various ways. Also, in describing the preferred embodiments, specific terminology will be resorted to for the sake of clarity. It is to be understood that each specific term includes all technical equivalents that operate in a similar manner to accomplish a similar purpose. Where possible, components of the drawings that are alike are identified by the same reference numbers.

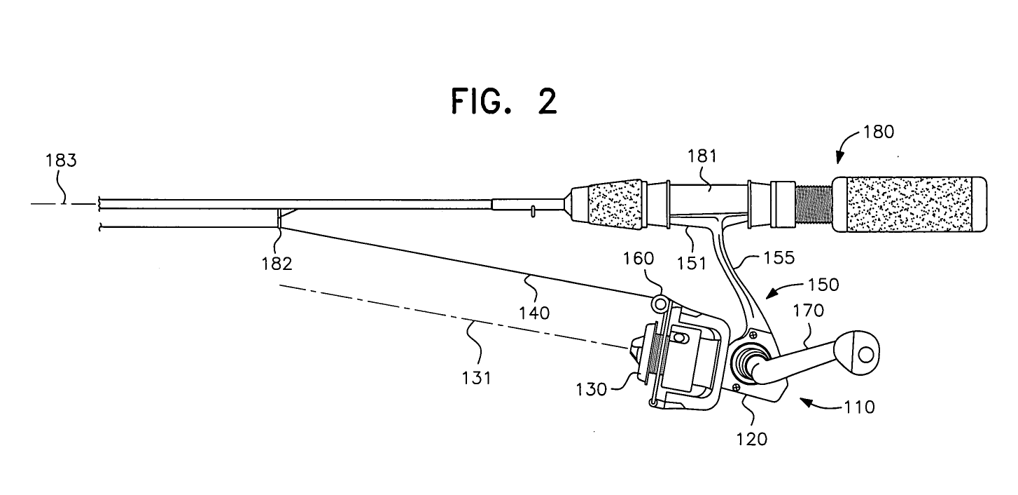

Referring now specifically to FIG. 2 of the drawings, a fishing rod reel in accordance with the present invention is generally designated by reference number 110. The reel 110 includes generally a reel body 120 with a spool 130 that holds a supply of fishing line 140, a rotor (not illustrated because it is located within reel body 120) that rotates a bail 160 around the spool 130, a rotor handle 170 rotatably disposed in the reel body 120, and a reel “neck” or mounting arm, generally designated by reference numeral 150, configured for mounting the reel 110 to a rod, generally designated by reference numeral 180, at a rod grip section 181. The mounting arm 150 includes a mounting foot 151 that is attachable to the rod 180 and a mounting neck 155 that connects the mounting foot 151 to the reel body 120.

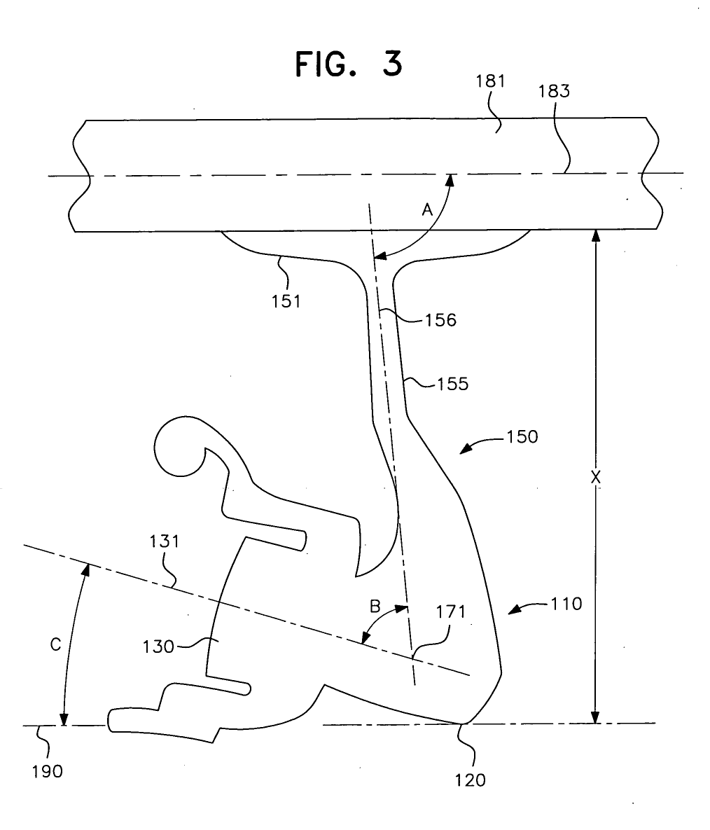

As illustrated in FIGS. 2 and 3, the mounting arm 150 is angled relative to both the rod 180 and to the line spool 130. The mounting arm 150 is configured such that an angle “A” between (i) a longitudinal axis 183 of the rod 180 and (ii) a longitudinal axis 156 of the mounting neck 155 that extends from the mounting foot 151 to a rotation axis 171 of the rotor handle 170 is less than 90°. According to a preferred embodiment of the invention, the angle “A” is about 85°.

The reel body 120 is configured such that an angle “B” between a longitudinal axis 131 of the spool 130 and the longitudinal axis 156 of the mounting neck 155 is from 54° to 84°. According to a preferred embodiment of the invention, the angle “B” is about 69°.

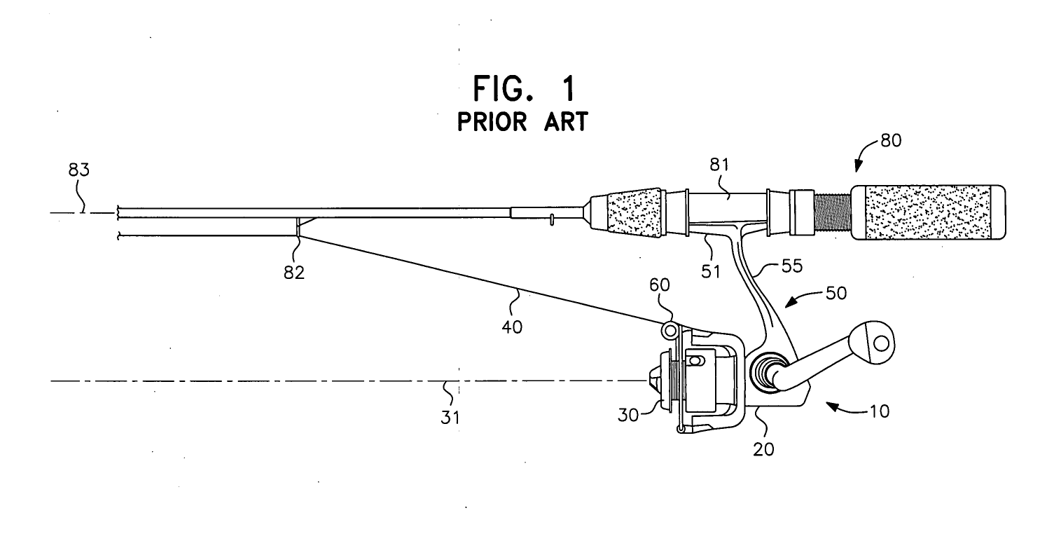

Furthermore, the reel 110 is configured such that when angle “A” is 85°, an angle “C” between the longitudinal axis 131 of the spool 130 and an axis 190 parallel to the longitudinal axis 183 of the rod 180 is from 1° to 31°. According to a preferred embodiment of the invention, the angle “C” is about 16°. In a conventional reel, the angle “C” is 0°, i.e., the reel is configured such that the longitudinal axis 31 of the spool is parallel to the rod axis 83 (see FIG. 1).

The reel 110 according to the present invention includes at least the following advantages. First, by virtue of the above-described angled configurations, the reel spool 130 is better aligned with the line guide 182. This alignment creates a smoother transfer of line 140 from the spool 130 at the bail 160 into the line guide 182. As a result, there is less friction created by the line 140 as it flows from the spool 130 into the line guide 182. Because there is less friction, casting distance increases and line retrieve is smoother. The smooth retrieve effect is especially pronounced on shorter rods, such as those used for ice fishing.

Second, also by virtue of the aforementioned configurations of the mounting neck 155 and of the reel body 120, the reel 110 can be mounted at an increased distance away from the rod grip 181. This distance is designated as “X” in FIG. 3. That is, the aforementioned configurations provide an angle between the line 140 leaving the reel spool 130 at the bail 160 and the line guide 182 that is less steep or severe than that associated with a conventional spinning reel. As a result, the distance “X” at which the reel 110 can be mounted away from the rod grip 181 can be greater, thereby providing increased clearance between the reel's bail 160 and the user's fingers. This advantage is especially attractive to a user with larger fingers, and for cold weather fishing when the user is wearing gloves or mittens. According to a preferred embodiment of the invention, the distance “X” is about 10.8 cm.

It is not intended that the present invention be limited to the specific device described herein. The foregoing is considered as illustrative only of the principles of the invention. For example, although the reel has been described in the context of a spinning reel, the reel could be another type, such as, for example, a spincasting reel.

Further, numerous modifications and changes will readily occur to those skilled in the art, it is not desired to limit the invention to the exact construction and operation shown and described, and, accordingly, all suitable modifications and equivalents may be resorted to, falling within the scope of the invention.

What is claimed is:

1. A fishing reel for use with a fishing rod, comprising a reel body that includes a spool holding a supply of fishing line, a rotor that rotates a bail around said spool, and a rotor handle rotatably disposed in said reel body, and a mounting arm configured for mounting said reel to said rod, said mounting arm including a mounting foot that is attachable to said rod and a mounting neck that connects said mounting foot to said reel body,
said mounting arm being configured such that an angle between (i) a longitudinal axis of said rod and (ii) a longitudinal axis of said mounting neck that extends from said mounting foot to a rotation axis of said rotor handle is less than 90°, and
said reel body being configured relative to said mounting arm such that an angle between a longitudinal axis of said spool and said longitudinal axis of the mounting neck is from 54° to 84°.

2. The reel according to claim 1, wherein said angle between said longitudinal axis of the rod and said longitudinal axis of the mounting neck is 85°.

3. The reel according to claim 1, wherein said angle between said longitudinal axis of the spool and said longitudinal axis of the mounting neck is 69°.

4. The reel according to claim 1, wherein said mounting neck axis extends from a center bottom portion of said mounting foot at a point of attachment thereof to said rod.

5. The reel according to claim 4, wherein said angle between said longitudinal axis of the rod and said longitudinal axis of the mounting neck is relative to a portion of said rod disposed rearward of said center bottom portion of the mounting foot.

6. The reel according to claim 2, wherein said spool axis is inclined toward said rod axis at an angle of from 1° to 31°.

7. The reel according to claim 6, wherein said spool axis is inclined toward said rod axis at an angle of 16°.

8. The reel according to claim 1, wherein a distance from a bottom edge of said mounting foot to a portion of said reel body is 10.8 cm.

9. A fishing reel for use with a fishing rod, comprising (a) a reel body with a spool holding a supply of fishing line, a rotor that rotates a bail around said spool, and a rotor handle rotatably disposed in said reel body, and (b) a mounting arm configured for mounting said reel to said rod, said mounting arm including a mounting foot that is attachable to said rod and a mounting neck that connects said mounting foot to said reel body,
said mounting arm being configured such that an angle between (i) a longitudinal axis of said rod and (ii) a longitudinal axis of said mounting neck that extends from said mounting foot to a rotation axis of said rotor handle is 85°, and
said reel body being configured relative to said mounting arm such that a longitudinal axis of said spool is inclined toward said rod axis at an angle of from 1° to 31°.

10. A fishing rod and reel comprising:
(a) a fishing rod having a longitudinal axis; and
(b) a fishing reel that includes a reel body having a spool holding a supply of fishing line, a rotor that rotates a bail around said spool, and a rotor handle rotatably disposed in said reel body, and a mounting arm configured for mounting said reel to said rod, said mounting arm including a mounting foot that is attachable to said rod and a mounting neck that connects said mounting foot to said reel body,
said mounting arm being configured such that an angle between (i) said longitudinal axis of the rod and (ii) a longitudinal axis of said mounting neck that extends from said mounting foot to a rotation axis of said rotor handle is less than 90°, and
said reel body being configured relative to said mounting arm such that an angle between a longitudinal axis of said spool and said longitudinal axis of the mounting neck is from 54° to 84°.

11. The fishing rod and reel according to claim 10, wherein said angle between said longitudinal axis of the rod and said longitudinal axis of the mounting neck is 85°.

12. The fishing rod and reel according to claim 10, wherein said angle between said longitudinal axis of the spool and said longitudinal axis of the mounting neck is 69°.

13. The fishing rod and reel according to claim 10, wherein said mounting neck axis extends from a center bottom portion of said mounting foot at a point of attachment thereof to said rod.

14. The fishing rod and reel according to claim 13, wherein said angle between said longitudinal axis of the rod and said longitudinal axis of the mounting neck is relative to a portion of said rod disposed rearward of said center bottom portion of the mounting foot.

15. The fishing rod and reel according to claim 11, wherein said spool axis is inclined toward said rod axis at an angle of from 1° to 31°.

16. The fishing rod and reel according to claim 15, wherein said spool axis is inclined toward said rod axis at an angle of 16°.

17. The fishing rod and reel according to claim 10, wherein a distance from a bottom edge of said mounting foot to a portion of said reel body is 10.8 cm.
